(19) United States
(12) Patent Application Publication
(10) Pub. No.: US 2013/0086467 A1
(43) Pub. Date: Apr. 4, 2013

(54) SYSTEM FOR SENDING A FILE FOR VIEWING ON A MOBILE DEVICE

(71) Applicants: Arnaud Claude WEBER, Saratoga, CA (US); Tyler William ODEAN, San Francisco, CA (US); Jay Pierre CIVELLI, Sunnyvale, CA (US); Sanjeev RADHAKRISHNAN, San Jose, CA (US); Glen MURPHY, Palo Alto, CA (US); Roma Rajni SHAH, San Francisco, CA (US); Yevgeniy Alexandrovich GUTNIK, Cupertino, CA (US)

(72) Inventors: Arnaud Claude WEBER, Saratoga, CA (US); Tyler William ODEAN, San Francisco, CA (US); Jay Pierre CIVELLI, Sunnyvale, CA (US); Sanjeev RADHAKRISHNAN, San Jose, CA (US); Glen MURPHY, Palo Alto, CA (US); Roma Rajni SHAH, San Francisco, CA (US); Yevgeniy Alexandrovich GUTNIK, Cupertino, CA (US)

(73) Assignee: GOOGLE INC., Mountain View, CA (US)

(21) Appl. No.: 13/306,938

(22) Filed: Nov. 29, 2011

Related U.S. Application Data
(60) Provisional application No. 61/542,769, filed on Oct. 3, 2011.

(51) Int. Cl. G06F 15/16; G06F 3/048; G06F 17/21

(52) U.S. Cl. 715/239; 709/217; 715/780

(57) ABSTRACT

Methods for sending a file stored in a first format on a non-mobile device to a mobile device in a second format suitable for viewing on the mobile device are provided. In one aspect, a method includes receiving a request to transmit a file converted from a first format to a second format to a mobile device, and storing the file in the second format suitable for viewing on the mobile device. The method also includes sending an access notification for the converted file to the mobile device. The access notification provides access to the converted file. Systems, graphical user interfaces, and machine-readable media are also provided.

### CROSS-REFERENCE TO RELATED APPLICATIONS

The present application claims the benefit of priority under 35 U.S.C. §119 from U.S. Provisional Patent Application Ser. No. 61/542,769 entitled “System for Sending a File for Viewing on a Mobile Device,” filed on Oct. 3, 2011, the disclosure of which is hereby incorporated by reference in its entirety for all purposes.

### BACKGROUND

1. Field

The present disclosure generally relates to the transmission of data over a network, and more particularly to the use of a computing device to communicate over a network.

2. Description of the Related Art

A user viewing a document on a desktop computer or laptop computer cannot easily view the same document in the same format and/or with the same access on a mobile device. For example, a user viewing a feature rich web page on her desktop computer will see a mobile (or otherwise more limited) version of the web page when attempting to load that web page on her mobile device. As another example, a user viewing a fifty page document stored on his computer cannot easily access the document on his tablet computer. If the user's desktop computer is part of a virtual private network that the tablet computer does not have access to, the user must manually upload the document to a shared public location with the tablet computer and ensure that his tablet computer has access to download the document and software to view the document. The user must then manually download the document.

### SUMMARY

In certain aspects of the disclosure, a computer-implemented method for sending a file stored in a first format on a non-mobile device to a mobile device in a second format suitable for viewing on the mobile device is disclosed. The method includes receiving a request to transmit a file converted from a first format to a second format to a mobile device, and storing the file in the second format suitable for viewing on the mobile device. The method also includes sending an access notification for the converted file to the mobile device. The access notification provides access to the converted file.

In certain aspects of the disclosure, a system for sending a file stored in a first format on a non-mobile device to a mobile device in a second format suitable for viewing on the mobile device is disclosed. The system includes a memory for storing a file converted from an initial format to a Portable Document Format (PDF) format, an image format, or Multipurpose Internet Mail Extensions HyperText Markup Language (MHTML) format, and a processor. The processor is configured to receive a request from a user to transmit the file converted from the initial format to a mobile device, and to send an access notification providing access to the converted file to the mobile device. The converted file is viewable on any mobile device and is in a format independent of the type of mobile device on which it is viewed.

In certain aspects of the disclosure, a graphical user interface for sending a file stored in a first format on a non-mobile device to a mobile device in a second format suitable for viewing on the mobile device is disclosed. The graphical user interface includes a display area for displaying a file stored in a first format to a user, and an input field for receiving a request from the user to transmit the file to a mobile device. The input of the request to transmit the file causes the file to be converted from the first format to a second format, and, subsequent to the conversion, causes an access notification for the converted file to be sent to the mobile device. The converted file is in a format viewable by the mobile device.

In certain aspects of the disclosure, a machine-readable storage medium comprising machine-readable instructions for causing a processor to execute a method for sending a file stored in a first format on a non-mobile device to a mobile device in a second format suitable for viewing on the mobile device is disclosed. The method includes receiving a request from a user to transmit a file converted from a first format to a second format to a mobile device, and receiving the file converted to the second format. The method also includes storing the file in the second format suitable for viewing on the mobile device, and transmitting the converted file or a link to the converted file to the mobile device.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary architecture for sending a file stored in a first format on a non-mobile device to a mobile device in a second format suitable for viewing on the mobile device.

FIG. 2 is a block diagram illustrating the exemplary clients and server from the architecture of FIG. 1 according to certain aspects of the disclosure.

FIG. 3 illustrates an exemplary process for sending a file stored in a first format on a non-mobile device to a mobile device in a second format suitable for viewing on the mobile device using the exemplary clients and server of FIG. 2.

FIGS. 4A-4D are exemplary screenshots associated with the exemplary process of FIG. 3.

FIG. 5 is a block diagram illustrating an exemplary computer system with which the clients and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system provides a user viewing a file in an initial format on a non-mobile device with the ability to automatically convert the file, on the non-mobile mobile device, into another format that can be viewed independent of the device on which it is loaded. Furthermore, the system automatically sends the file, once converted on the non-mobile device, from the non-mobile device to a server for storage. The server then provides access to the converted file to a mobile device, such as a smartphone, tablet computer, or projector. Thus, the user viewing a lengthy document (e.g., a Microsoft Word file) accessed from an internal private network on the user's desktop can choose to “print to phone,” and the document is automatically converted into a second format (e.g., PDF file) on the desktop computer and sent to a server, which stores and then sends the converted file to the user's tablet computer. When the user turns on the user's tablet computer on an airplane, where no access is available to either the internal private network or even a public network, the user has immediate access to the entire lengthy document as viewed on the user's desktop computer. Similarly, when a user viewing a feature-rich web page on the user's laptop computer chooses “print to phone” from the user's web browser, the web page is automatically converted into a second format (e.g., MHTML file) on the laptop computer and sent to a server for storage, and a notification from the server appears on the user's mobile phone asking the user if the user wants to download the web page for viewing. When downloaded, the user is able to view the web page as the user viewed it on the user's laptop computer.

Although many examples provided herein describe a user's file being stored in memory, the user can, at any time, delete the file from memory and/or opt out of having the user file stored in memory. Additionally, the user can, at any time, adjust appropriate privacy settings to selectively limit the types of files stored in memory. The user's files do not include and/or share a specific identification of the user (e.g., the user's name) unless otherwise specifically provided or directed by the user. Additionally, although the examples provided herein describe sending a file from a non-mobile device to a mobile device, the same file can be sent from one mobile device to another mobile device using the same system disclosed herein.

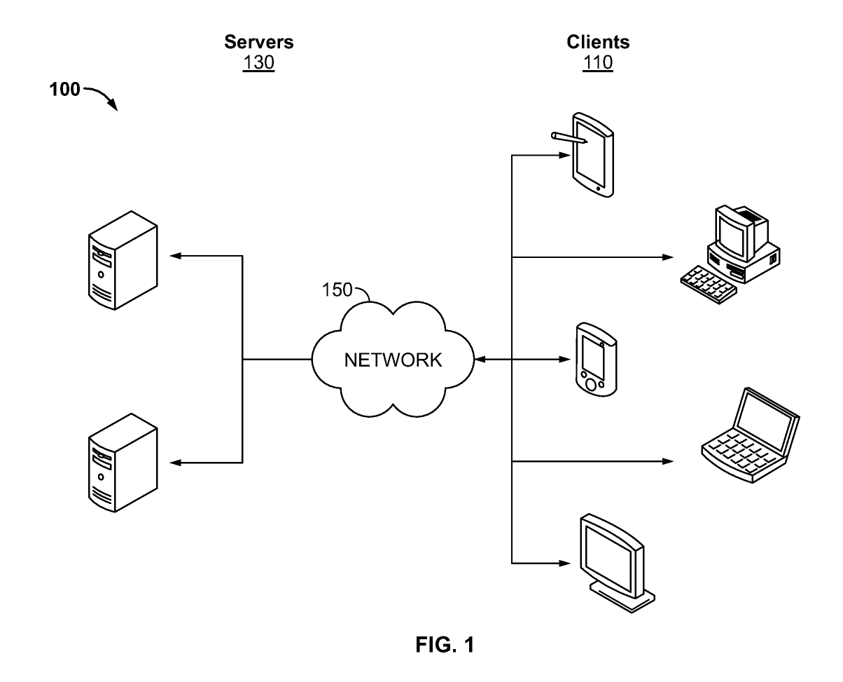

FIG. 1 illustrates an exemplary architecture 100 for sending a file stored in a first format on a non-mobile device to a mobile device in a second format suitable for viewing on the mobile device. The architecture 100 includes servers 130 and clients 110 connected over a network 150.

One of the many servers 130 is configured to host “provider” software (hereinafter “provider”) for providing a file, converted on a non-mobile client to a format viewable on a user's mobile client device 110, to the mobile client device in response to a user's request from a non-mobile client device 110. For purposes of load balancing, multiple servers 130 can host the provider and the converted file. The servers 130 can be any device having an appropriate processor, memory, and communications capability for hosting the provider and converted file.

The clients 110 to which the servers 130 are connected over the network 150 can be, for example, desktop computers, mobile computers, mobile devices (e.g., a smartphone, tablet computer, e-book device, PDA, or projector), set top boxes (e.g., for a television), video game consoles, or any other devices having appropriate processor, memory, and communications capabilities. For example, exemplary non-mobile clients 110 include desktop computers, laptop computers, set top boxes, and video game consoles with appropriate hardware and software to view a file in a format dependent on the non-mobile client 110 (“device-dependent format”). Exemplary device-dependent formats include proprietary formats such as DOC format (Microsoft Word Document), XLS format (Microsoft Excel spreadsheet file), and PPT format (Microsoft PowerPoint Presentation file). Exemplary device-dependent formats also include linked formats, such as HyperText Markup Language (HTML) format, where the data for the displayable content of the file may require retrieval over a network at the time of display.

Exemplary mobile clients 110 include smartphones, tablet computers, and projectors with appropriate hardware and software to view a file in a format independent of the mobile client 110 (“device-independent format”). Device independent formats include self-contained formats, such as Portable Document Format (PDF), Multipurpose Internet Mail Extensions HTML (MHTML) format, image format (e.g., JPEG, TIFF, PNG, GIF, BMP, with or without raster graphics), and other formats where the data for the displayable content of the file is contained within the file.

The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

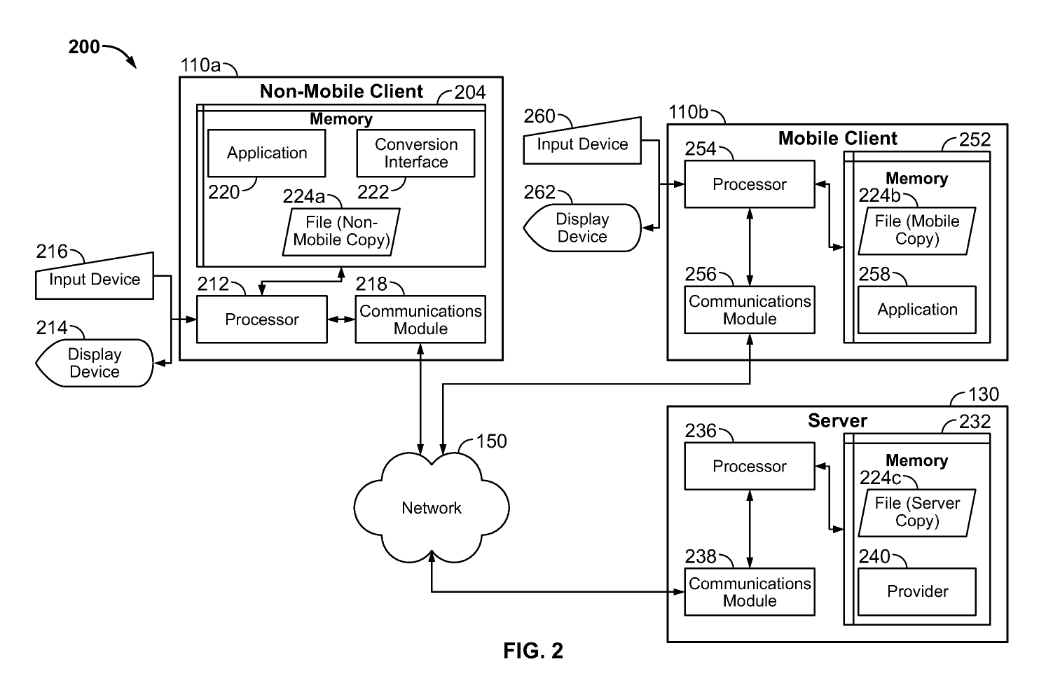

FIG. 2 is a block diagram 200 illustrating an exemplary server 130 and clients 110a and 110b in the architecture 100 of FIG. 1 according to certain aspects of the disclosure. The non-mobile client 110a, mobile client 110b, and the server 130 are connected over the network 150 via respective communications modules 218, 256, and 238. The communications modules 218, 256, and 238 are configured to interface with the network 150 to send and receive information, such as data, requests, responses, and commands to other devices on the network. The communications modules 218, 256, and 238 can be, for example, modems or Ethernet cards.

The non-mobile client 110a includes a processor 212, the communications module 218, and a memory 204 that includes an application 220, a conversion interface 222, and a non-mobile copy of a file 224a being viewed in the application 220. The non-mobile copy of the file 224a is in a device-dependent format, and the application 220 on the non-mobile client 110a is likewise device dependent. The application 220 on the non-mobile client 110a is configured to display or otherwise provide the file 224a to a user of the non-mobile client 110a in the device-dependent format on the display device 214.

The software conversion interface 222 can be a plug-in, snap-in, extension, driver, application, or other software component to add conversion and sending abilities to the application 220. For example, the conversion interface 222 can be a web browser application or web browser extension when the application 220 is a web browser, or a virtual printer registered with the non-mobile client 110a when the application 220 is a document editing software application. The conversion interface 222 can, for example, display an input field (e.g., a button labeled “print to mobile device” or a virtual printer in a print screen) as part of the application for receiving a user request from the input device 216 to send the non-mobile copy of the file 224a to the mobile client 110b. When activated (e.g., by the user clicking on the displayed button), the processor 212 of the non-mobile client 110a is instructed by the conversion interface 222 to convert the non-mobile copy of the file 224a, which is in a device-dependent format, into a device-independent format. The conversion interface 222 provides the appropriate file format encoders, including, for example, a PDF encoder, image encoder, and MHTML encoder for converting the file 224a. The conversion interface 222 can replace appropriate portions of the non-mobile copy of the file 224a during conversion, as necessary. For example, JavaScript can be stripped, and canvas, video, and/or plug-in elements can be replaced by an image showing their content when converting between file formats. Once the file 224a is converted, the processor 212 sends the user request along with a copy of the converted file over the network 150 via the communications module 218 to the communications module 238 of the server 130.

The server 130 includes a processor 236, the communications module 238, and a memory 232. The memory 232 of the server 130 includes a provider 240. The processor 236 of the server 130 is configured to execute instructions, such as instructions physically coded into the processor 236, instructions received from software in memory 240, or a combination of both. For example, the processor 236 of the server 130 executes instructions from the provider 240 to receive both the request to send the non-mobile copy of the file 224a to the mobile client 110b and the non-mobile copy of the file 224a. The processor 236 keeps the converted file in memory 232 as a server copy of the file 224c. Mobile client 110b will be sent an access notification which will provide either a link to the server copy of the file 224c, or will include the server copy of the file 224c.

In certain aspects, if the converted file needs to be converted into a different format, the provider 240 of the server 130 includes appropriate file format encoders, including, for example, the PDF encoder, image encoder, and MHTML encoder described above, or alternative encoders. Specifically, if the non-mobile client 110a does not have the appropriate file format encoders for converting the non-mobile copy of the file 224a to a format readable by the mobile client 110b, then the server 130 can convert the non-mobile copy of the file 224a received from the non-mobile client 110a into an appropriate format. For example, the non-mobile client 110a can send the non-mobile copy of the file 224a to the server 110 in MHTML format converted from the HTML format in which the non-mobile copy of the file 224a was viewed on the non-mobile client 110a. The server 130 can then store the non-mobile copy of the file 224a in memory 232 as a server copy of the file 224c in the MHTML format, and poll the mobile client 110b to determine whether the mobile client 110b would like to receive the file. The mobile client 110b then responds by confirming a request to receive the file in PDF format, in response to which the server 130 converts the server copy of the file 224c into PDF format and sends the server copy of the file 224c to the mobile client 110b.

The mobile client 110b includes a processor 254, the communications module 218, and a memory 220. If the access notification from the server 130 does not include the server copy of the file 224c (e.g., it instead includes a link to the file 224c), the processor 254 of the mobile client 110b can automatically download a copy of the server copy of the file 224c or display a notification to the user to ask whether to download a copy of the server copy of the file 224c. Once the server copy of the file 224c is received at the mobile client 110b, it is stored in memory 252 as a mobile copy of the file 224b. As discussed earlier, the mobile copy of the file 224b is in a device independent format. Thus, the processor 254 of the mobile client 110b can either automatically display the mobile copy of the file 224b to the user on the display device 262 using an appropriate application 258 in the memory 252 of the mobile client, or display the mobile copy of the file 224b to the user in response to an instruction from the user to do so entered using an input device 260 of the mobile client 110b.

For example, if the mobile client 110b is a smartphone or a tablet computer, then the mobile copy of the file 224b can be displayed in application 258 that is both specifically designed for the smartphone or the tablet, and configured to display device-independent formatted files in the specific format of the mobile copy of the file 224b. If the mobile client 110b is a projector, such as a network projector that is configured to receive the access notification over the network 150 by having appropriate software to monitor communications over the network 150 designated for the projector, then the projector can automatically download and begin projection of the mobile copy of the file 224b.

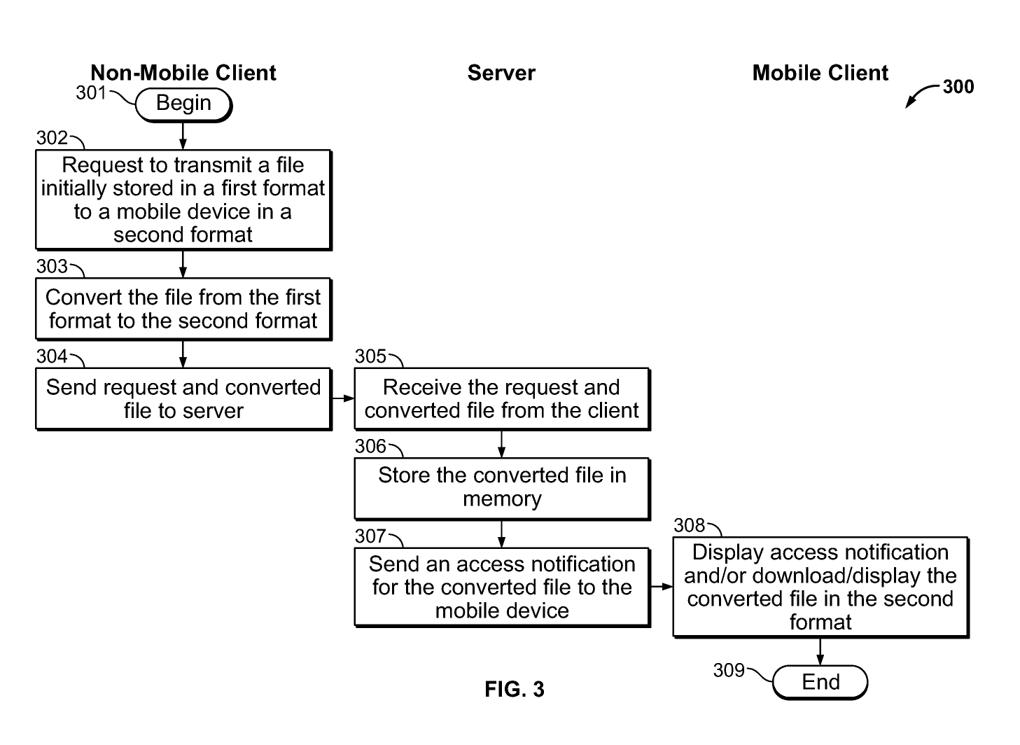

FIG. 3 illustrates an exemplary process 300 for sending a file stored in a first format on a non-mobile device to a mobile client device in a second format suitable for viewing on the mobile device using the exemplary non-mobile client 110a, mobile client 110b, and server 130 of FIG. 2. The process 300 begins in step 301 when a non-mobile copy of a file 224a is provided in a device-dependent format in an application 220 on the non-mobile client 110a. When conversion interface 222 associated with the application receives a request to transmit the non-mobile copy of the file 224a to the mobile client 110b in a device-independent format in step 302, in step 303, the processor 212 of the mobile client 110b converts file 224a from the device-dependent format to the device-independent format. In step 304, the request to send the non-mobile copy of the file 224a to the mobile client 110b, and the converted file, are sent to the server 130 over the network 150, and received by the server 130 in step 305. In step 306, the server 130 stores a copy of the converted file in memory 232 as a server copy of the file 224c, and in step 307 sends an access notification for the server copy of the file 224c to the mobile client 110b over the network 150. In step 308, the mobile client 110b displays the access notification. Display of the access notification can include downloading of the converted file and display of the converted file in the device independent format. The process 300 ends in step 309.

FIG. 3 set forth an exemplary process 300 for sending a file stored in a first format on a non-mobile device to a mobile device in a second format suitable for viewing on the mobile device using the exemplary non-mobile client 110a, mobile client 110b, and server 130 of FIG. 2. Two examples will now be described using the exemplary process 300 of FIG. 3. The first example will refer to a non-mobile client 110a that is a desktop computer, a mobile client 110b that is a tablet computer, and a non-mobile copy of a file 224a that is a confidential internal document accessible on an internal private network of the desktop computer. The second example will refer to a non-mobile client 110a that is a laptop computer, a mobile client 110b that is a smartphone, and a non-mobile copy of a file 224a that is a feature rich web page natively viewable by non-mobile web browsers.

Turning to the first example, the process 300 begins in step 301 when an internal private network confidential document 224a in a device-dependent DOC format is opened by a user of a desktop computer 110a in a document editing application 220. The operating system of the desktop computer 110a has been previously configured with a conversion interface 222 to provide an option for applications such as the document editing application 220 to “print” to a mobile device. Specifically, the conversion interface 222 is a web-based common print dialog or application programming interface (API) configured to receive print jobs on behalf of the provider on the server 130, and then send the print jobs to the server 130 for appropriate processing. The conversion interface 222, when initially installed by the user, prompted the user to identify the target mobile device. In response, the user identified the user's tablet computer 110b.

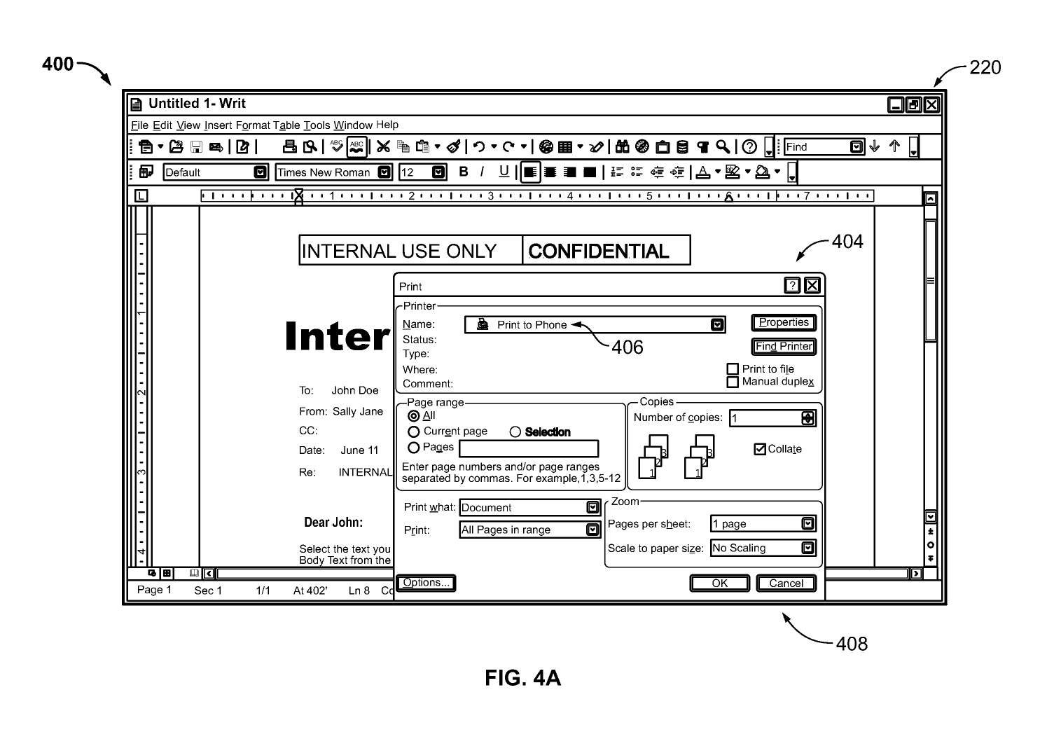

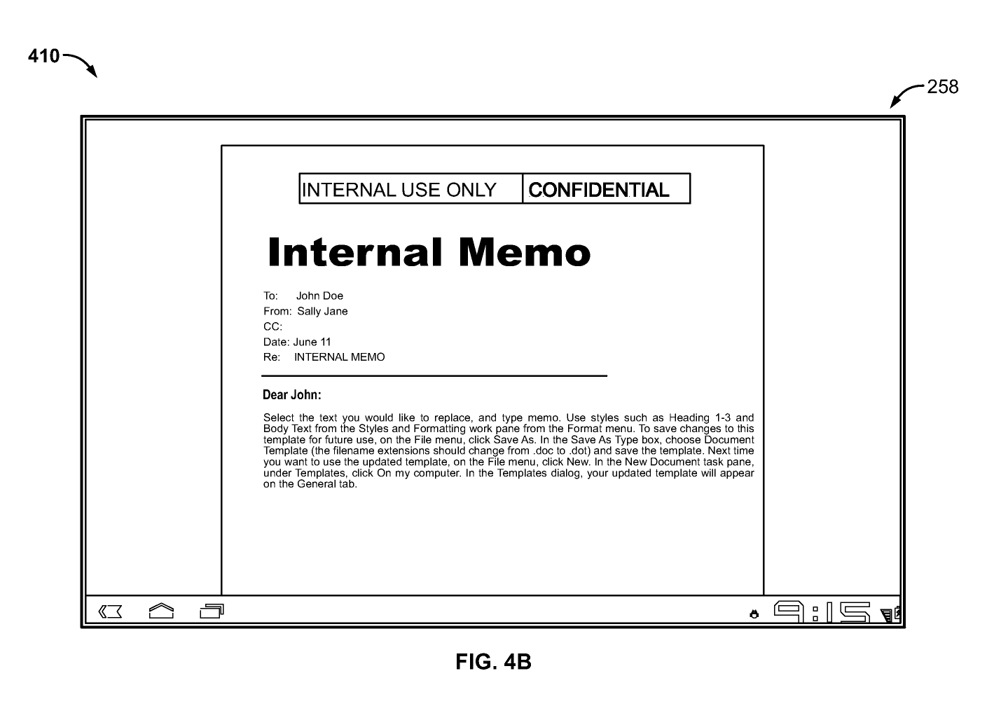

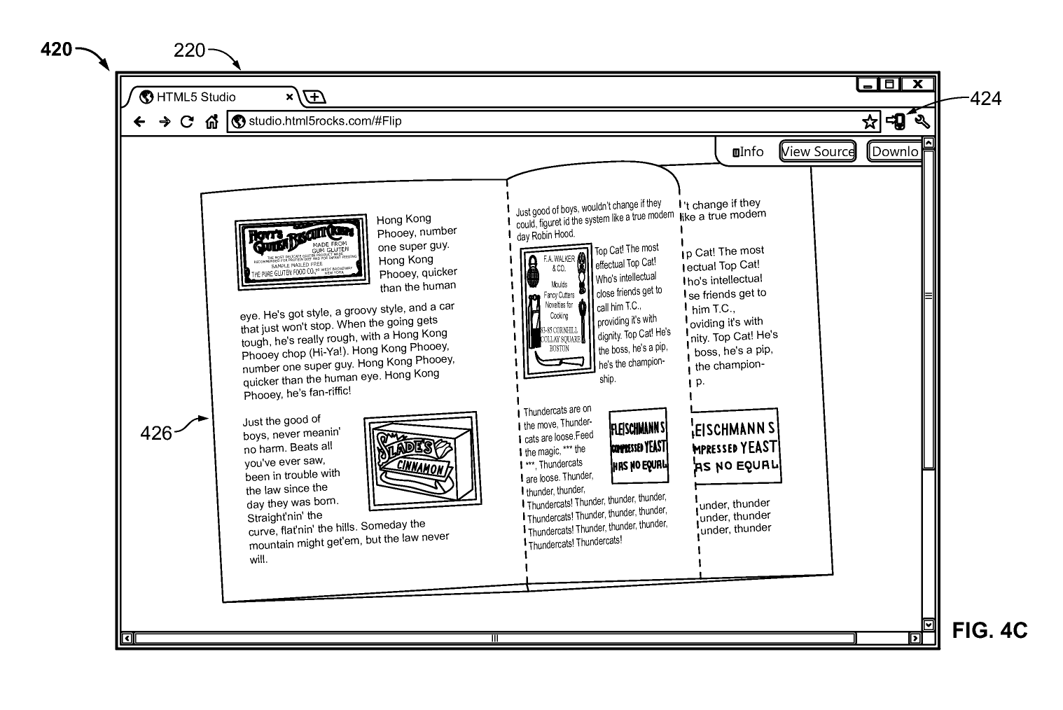

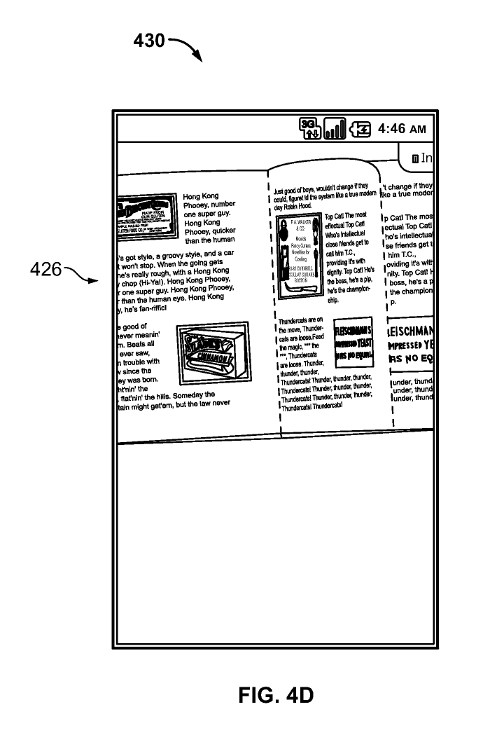

Returning to the example, the user clicks the “print” button displayed in the document editing application 220 on the desktop computer 110a, which causes the desktop computer 110a to display a print window 404 illustrated in the exemplary screenshot 400 of FIG. 4A. The print window 404 lists a printer named “Print to Phone” 406, representing the conversion interface 222. When the user in step 302 presses the “OK” button 408 in the print window 404, in step 303 the conversion interface 222 on the desktop computer 110a converts the internal private network confidential document 224a from DOC format to a device-independent format, namely PDF format, on the desktop computer 110a. In step 304 the desktop computer 110a sends a copy of converted PDF format file to the server 130 for storage along with the request for the server 130 to send the file to the tablet computer 110b.

The server 130 in step 305 receives the converted copy of the internal private network confidential document 224a in PDF format, and in step 306 stores a server copy of the internal private network confidential document 224c in memory 232. The copy of the internal private network confidential document 224c in memory 232 can be stored on a dedicated documents server accessible by the user, and tagged with an identification of the mobile device to which the converted file is to be sent. In step 307, the server 130 sends an access notification for the converted file to the mobile client 110b over the network 150 that includes a copy of the converted file 224c. The server 130 of step 307 can be a dedicated synchronization server that retrieves all documents from the documents server of step 306 tagged with the identification of the mobile device (e.g., the tablet computer 110b) for inclusion in the access notification. In step 308, the tablet computer 110b displays the access notification that the converted file 224c has been received and is downloaded locally to the tablet computer 110b. The process 300 ends in step 309. When the user later activates his tablet computer 110b on an airplane, where no network access is available, the user can view the internal private network confidential document 224b in an appropriate document viewing application 258 on his tablet computer 110b as illustrated in the exemplary screenshot 410 of FIG. 4B. The tablet computer 110b simply retrieves the document 224b from memory 252.

Turning to the second example featuring a non-mobile client 110a that is a laptop computer, a mobile client 110b that is a smartphone, and a non-mobile copy of a file 224a that is a feature rich web page natively viewable by non-mobile web browsers, the process 300 begins in step 301 when a user opens a feature rich HTML5 web page 224a in device-dependent HTML format in a non-mobile web browser 220 on her laptop computer 110a. FIG. 4C illustrates an exemplary screenshot 420 of content 426 from the feature rich web page 224a displayed in the non-mobile web browser 220 on the laptop computer 110a. The non-mobile web browser 220 includes an installed web browser extension 222 that has added a button 424 to the non-mobile web browser 220. In step 302 the user presses the button 424 using her mouse 216 in order to send a “snapshot” of the feature rich web page 224a to her smartphone 110b. In response, the web browser extension 222 in step 303 converts the feature rich web page 224a from HTML format into MHTML format on the laptop computer 110a, and in step 304 the laptop computer 110a sends the request to send the snapshot of the MHTML formatted web page to the server 130 and the MHTML formatted web page to the server 130.

In step 305, the server 130 receives the MHTML formatted web page and the request, and in step 306 stores the MHTML formatted web page as a server copy of the web page 224c in a portion of the memory 232 dedicated for user files. The server copy of the web page 224c in memory 232 can further be tagged with an identification of the mobile device to which the converted file is to be sent and the original address of the feature rich web page 224a. In step 307, the server 130 sends an access notification for the server copy of the web page 224c to the smartphone 110b over the network 150. The server 130 of step 307 can be a dedicated synchronization server that retrieves all files from the documents portion of the memory 232 of step 306 tagged with the identification of the smartphone 110b for inclusion in the access notification.

In step 308, the smartphone 110b receives the access notification and displays the access notification on its display 262. The access notification includes a link to the server copy of the web page 224c and an optional prompt to the user asking the user if she wants to download the server copy of the web page 224c for viewing on the smartphone 110b. When the user agrees to download and view the server copy of the web page 224c, the server copy of the web page 224c is downloaded and stored locally as a mobile copy of the web page 224b on the smartphone 110b, and then loaded in an appropriate application 258 on the smartphone 110b to be viewed, as illustrated in the exemplary screenshot 430 of FIG. 4D. The displayed mobile copy of the web page 224b includes the content 426 from the feature rich web page 224a the user viewed on her laptop computer 110a. Due to the conversion to MHTML format on the laptop 110a, the content 426 is displayed on the smartphone 110b in non-interactive form. For instance, the displayed mobile copy of the web page 224b can block all input events but except for scroll events to ensure that the mobile copy of the web page 224b is static while still letting the user scroll to view the content 426. The exemplary screenshot 430 from the smartphone 110b can also include an indicator (not illustrated) identifying the content 426 as a snapshot of the original feature rich web page 224a, as well as the original address (not illustrated) of the feature rich web page 224a. The process 300 ends in step 307.

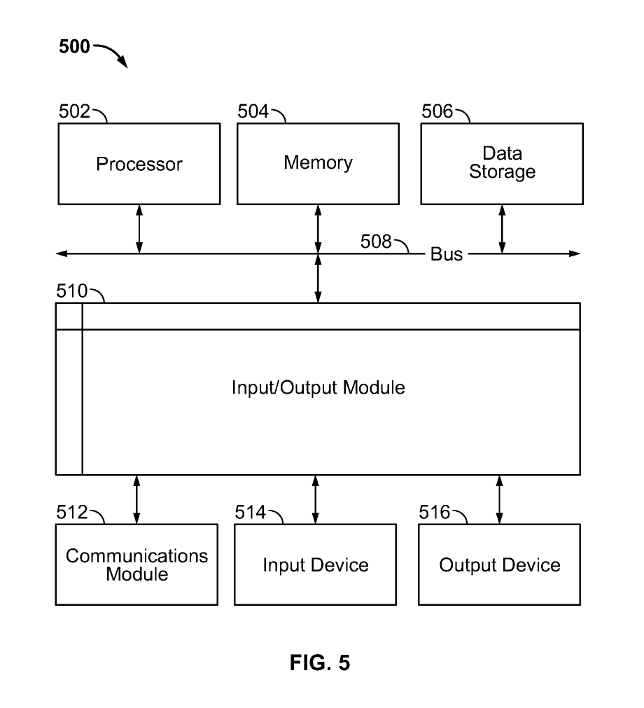

FIG. 5 is a block diagram illustrating an exemplary computer system 500 with which the clients 110a and 110b and server of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., clients 110a and 110b and server 130) includes a bus 508 or other communication mechanism for communicating information, and a processor 502 (e.g., processor 212, 254, and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 204, 252, and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 (e.g., communications module 218, 256, and 238) include networking interface cards, such as Ethernet cards and modems. In certain aspects, the input/output module 510 is configured to connect to a plurality of devices, such as an input device 514 (e.g., input device 216 and 260) and/or an output device 516 (e.g., display device 214 and 262). Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as a CRT (cathode ray tube) or LCD (liquid crystal display) monitor, for displaying information to the user.

According to one aspect of the present disclosure, the clients 110a and 110b and servers 130a, 130b, and 130c can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., communication network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Systems, methods, user interfaces, and machine-readable media for sending a file for viewing on a mobile device have been described. A user viewing a file in a first, device-dependent format on a non-mobile device can request to send the file to a mobile-device for viewing. The file is converted from the first, device-dependent format to a second, device-independent format and stored on a server accessible by the mobile device. The server sends a notification to the mobile device to retrieve the converted file, and the mobile device then retrieves the converted file for viewing in device-independent format on the mobile device.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for sending a file stored in a first format on a non-mobile device to a mobile device in a second format suitable for viewing on the mobile device, the method comprising:
receiving a request to transmit a file converted from a first format to a second format to a mobile device, wherein when the file comprises an active element, the active element is replaced with a static element indicative of the active element when the file is converted from the first format to the second format;
storing the file in the second format suitable for viewing on the mobile device; and
sending an access notification for the converted file to the mobile device,
wherein the access notification provides access to the converted file,
wherein the active element comprises at least one of a script, a video, or a plug-in element.

2. The computer-implemented method of claim 1, wherein the file is stored on a server.

3. The computer-implemented method of claim 2, wherein the file is converted from the first format to the second format by the server.

4. The computer-implemented method of claim 3, wherein the file is received in the first format from a client, wherein the file was converted to the first format by the client from a third format suitable for viewing on the client.

5. The computer-implemented method of claim 1, wherein the file is downloaded by an application in response to receiving the access notification.

6. The computer-implemented method of claim 1, wherein sending the access notification comprises sending a link to the converted file.

7. The computer-implemented method of claim 1, wherein the second format is at least one of a Portable Document Format (PDF) format, an image format, or Multipurpose Internet Mail Extensions HyperText Markup Language (MHTML) format.

8. The computer-implemented method of claim 1, wherein the request to transmit the file comprises a request to print the file to the mobile device.

9. The computer-implemented method of claim 1, wherein the file is a web page in HyperText Markup Language (HTML) format.

10. The computer-implemented method of claim 1, wherein the mobile device is a smartphone, a tablet computer, an e-book device, a projector, or a television set-top box.

11. A system for sending a file stored in a first format on a non-mobile device to a mobile device in a second format suitable for viewing on the mobile device, the system comprising:
a memory for storing a file converted from an initial format to a Portable Document Format (PDF) format, an image format, or Multipurpose Internet Mail Extensions HyperText Markup Language (MHTML) format, wherein when the file comprises an active element, the active element is replaced with a static element indicative of the active element when the file is converted from the initial format to the PDF format, image format, or MHTML format; and
a processor configured to receive a request from a user to transmit the file converted from the initial format to a mobile device, and to send an access notification providing access to the converted file to the mobile device,
wherein the converted file is viewable on any mobile device and is in a format independent of the type of mobile device on which it is viewed,
wherein the active element comprises at least one of a script, a video, or a plug-in element.

12. The system of claim 11, wherein the file is converted from the initial format to the PDF format, image format, or MHTML format by the system.

13. The system of claim 12, wherein the file is received in the initial format from a client, wherein the file was converted to the initial format by the client device from a third format suitable for viewing on the client.

14. The system of claim 11, wherein the file is downloaded by an application in response to receiving the access notification.

15. The system of claim 11, wherein the processor being configured to send the access notification comprises the processor being configured to send a link to the converted file.

16. The system of claim 11, wherein the request to transmit the file comprises a request to print the file to the mobile device.

17. The system of claim 11, wherein the file is a web page in HyperText Markup Language (HTML) format.

18. The system of claim 11, wherein the mobile device is a smartphone, a tablet computer, an e-book device, a projector, or a television set-top box.

19. A client device comprising:
a display configured to display a file stored in a first format to a user; and
an input device configured to receive a request from the user to transmit the file to a mobile device;
wherein the input of the request to transmit the file causes the file to be converted from the first format to a second format, and when the file comprises an active element, the active element is replaced with a static element indicative of the active element when the file is converted from the first format to the second format, and, subsequent to the conversion, the input of the request causes an access notification for the converted file to be sent to the mobile device,
wherein the converted file is in a format viewable by the mobile device,
wherein the active element comprises at least one of a script, a video, or a plug-in element.

20. A non-transitory machine-readable storage medium comprising machine-readable instructions for causing a processor to execute a method for sending a file stored in a first format on a non-mobile device to a mobile device in a second format suitable for viewing on the mobile device, the method comprising:
receiving a request from a user to transmit a file converted from a first format to a second format to a mobile device, wherein when the file comprises an active element, the active element is replaced with a static element indicative of the active element when the file is converted from the first format to the second format;
receiving the file converted to the second format;
storing the file in the second format suitable for viewing on the mobile device; and
transmitting the converted file or a link to the converted file to the mobile device,
wherein the active element comprises at least one of a script, a video, or a plug-in element.

21. The computer-implemented method of claim 3, wherein the file is received by the server in the first format from a client when the client is unable to convert the file from the first format to the second format.

22. The system of claim 12, wherein the file is received by the system in the first format from a client when the client is unable to convert the file from the first format to the second format.

23. The graphical user interface of claim 19, wherein the file is transmitted to a server in the first format from a client when the client is unable to convert the file from the first format to the second format.

24. The non-transitory machine-readable storage medium of claim 20, wherein the file is stored in the second format on a server, and wherein the file is received by the server in the first format from a client when the client is unable to convert the file from the first format to the second format.
